(19) United States
(12) Patent Application Publication
(10) Pub. No.: US 2006/0203411 A1
(43) Pub. Date: Sep. 14, 2006

(54) Multi-Purpose Interrupter for Cathodic Protection Systems

(76) Inventors: Julius Wessel Fourie, Houston, TX (US); Lee Steven Blankenstein, Austin, TX (US); Michael Patrick Devine, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/276,641

(22) Filed: Mar. 8, 2006

Related U.S. Application Data
(60) Provisional application No. 60/659,490, filed on Mar. 8, 2005.

(51) Int. Cl. H01H 73/00

(52) U.S. Cl. 361/115

(57) ABSTRACT

A multi-purpose interrupter for interrupting the current flow from a cathodic protection rectifier. The multi-purpose interrupter may be placed within a rugged enclosure and is configured to interface with one or more relays, is configured to interface with an RMU, is configured to interface with a selector switch, and is configured to be housed within an enclosure housing the cathodic protection rectifier. Responsive to a signal from the RMU or the selector switch, the multi-purpose interrupter is configured to interrupt the current flow from the cathodic protection rectifier.

This application claims the benefit of Provisional Application Ser. No. 60/659,490 filed Mar. 8, 2005.

### BACKGROUND

1. Field of the Present Invention

This invention relates to a cathodic protection rectifier and, more particularly, to a device for interrupting the current flow from a cathodic protection rectifier.

2. History of Related Art

It is known that all metallic structures that come in contact with a medium having the properties of an electrolyte are susceptible to the phenomenon of corrosion. In order to prevent/minimize corrosion, systems utilizing cathodic protection rectifiers (CPSs) are often employed.

In general, CPSs operate by utilizing an electrical current to oppose a corrosion current between the structure being protected and an electrolyte. There are generally two well known systems for generating opposing electrical currents, “sacrificial systems” and “impressed current systems.” In sacrificial systems, the current is supplied by another metal which is galvanically more reactive than the metal of the structure. For example, metals such as aluminum, magnesium, and zinc are galvanically more active than steel and may be used as “sacrificial anodes” to protect steel structures. In impressed current systems, a consumable metal is used to drain direct current (DC) supplied from an external source into an electrolyte, which passes to the structure to be protected. When more than one buried structure needs to be protected with one or more CPSs, it is common practice to install a bond, sometimes including a resistor, to control the amount of current flowing to each structure.

The applied current changes the voltage across the metal/soil interface, thereby changing the electrochemical state of the structure so that corrosion is mitigated. The voltage across the metal/soil interface is monitored to determine if adequate protection is being achieved. The measured voltage level is generally termed a “pipe-to-soil” potential. Various criteria are used in the industry to determine if the pipe-to-soil potential has been shifted sufficiently negative to mitigate corrosion. The most common criterion is that the potential difference, while the cathodic protection circuits are switched on, is more negative than −0.85 V. However, an error can be introduced in the measurement if taken while the cathodic protection circuits are switched on. In order to eliminate this error, all influencing sources of cathodic protection current are switched off simultaneously and the pipe-to-soil potential is measured (typically within 1 sec or less) after switching the current off. Such a test is referred to as an “interrupted survey.”

To facilitate an interrupted survey, it is common to temporarily install portable current interrupters into the cathodic protection circuit for the duration of the test. Interrupters are devices that synchronously cycle the current output of CPSs between ON and OFF, allowing an interrupted survey to be carried out. For the results to be valid, it is necessary not only to interrupt all of the influencing CPSs, but also all associated bonds within the system being tested. The interrupter is typically connected to a relay. Typically, mechanical or solid state relays are utilized. On some portable interrupters, this relay forms an integral part of the portable interrupter, all packaged into the same bulky enclosure. One disadvantage of this configuration is that the user is limited to a relay of only one particular type and capacity. Furthermore, the user is limited to only one relay per portable interrupter thereby necessitating the use of multiple portable interrupters at a location where multiple current sources need to be interrupted (e.g., locations where multiple CPSs are installed in close proximity of each other, such as within a 100 foot radius, or where a single CPS incorporates one or more bonds which have to be interrupted individually).

Portable interrupters are typically powered in a number of ways. One common method is to connect the interrupter to available primary AC supply, typically 110V or 220V, present in many CPSs. The internal electronic circuitry of portable interrupters operates off low voltage DC. Some portable interrupters have AC to DC converters built in for this purpose while others require an external AC/DC converter and accept a 12V DC power input. Sometimes an AC voltage supply is not available, for instance if the CPS is powered from solar power or with a thermal generator or if the CPS is a sacrificial system, or if a bond needs to be interrupted. In these situations, it is customary to power the portable interrupter with a battery having sufficient charge capacity to last the duration of a test. In some instances, a test may last for a number of days or even one week or more and a battery with substantial charge capacity, such as a rechargeable lead acid automotive battery having a charge capacity of 40 ampere hours or more may be required. Such a batteries are usually bulky, heavy, and inconvenient to use.

Synchronization of the various portable interrupters is typically achieved through synchronizing their internal clocks, using a clock reference unit as described in U.S. Pat. No. 4,356,444, or using Geographical Positioning Satellite (GPS) time signals as described in U.S. Pat. No. 6,617,855.

U.S. Pat. No. 6,617,855 describes a portable interrupter that is powered using either disposable alkaline batteries, or a connection to the DC output of a CPS for long term applications. This portable interrupter incorporates a solid state relay and associated heat sink resulting in an overall size of approximately 30 cm×15 cm×7.5 cm. Many situations exist where this interrupter will not fit inside existing CPS enclosures.

In order to check that CPSs are functioning correctly, the output of each CPS is monitored periodically, such as once every two months. Instead of physically visiting the CPSs, devices known as “remote monitoring units” or RMUs may be used to remotely monitor the rectifiers from a central location. These devices have input capabilities allowing the measurement of analog or digital values, as well as output capabilities allowing control of external devices, either using a discrete signal or a communication protocol which may include, but is not limited to, RS232 serial communication. These devices use some form of communication method to automatically transmit the measured status of a rectifier to a central location. A typical remote monitoring device for rectifiers using Low Earth Orbit (LEO) satellites as the communication link is described in U.S. Pat. No. 5,785,842. An RMU incorporating a GPS synchronized interrupter is described in U.S. Pat. No. 6,822,432. Each of the patents identified herein is hereby incorporated herein by this reference as if set forth in their entirety herein.

While installation of an interrupter at an RMU generally increases the speed and efficiency of an interrupted survey, the need for portable interrupters, however, continues to exist. Accordingly, it would be beneficial to implement an interrupter that can interchangeably be used as a portable interrupter or that can be interfaced to an RMU, having all the desired characteristics for either of these applications.

### BRIEF DESCRIPTION OF THE DRAWINGS

Objects and advantages of the invention will become apparent upon reading the following detailed description and upon reference to the accompanying drawings in which:

FIG. 1 is a schematic showing selected elements of a cathodic protection configuration, including a multi-purpose interrupter and an associated relay according to one embodiment of the present invention;

FIG. 2 is a block diagram showing selected sub-components of one embodiment of the multi-purpose interrupter of FIG. 1;

FIG. 3 is a block diagram showing a user interface suitable for use in the interrupter of FIG. 2;

FIG. 4 is a block diagram showing a multi-purpose interrupter and selector switch combination according to one embodiment of the present invention;

FIG. 5 is a schematic showing selected elements of a cathodic protection configuration emphasizing interface to an RMU;

FIG. 6 is a block diagram showing an interface between an RMU and a multi-purpose interrupter according to one embodiment of the present invention; and

FIG. 7 depicts a multi-purpose interrupter within a rugged enclosure according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the invention is limited only by the language of the appended claims.

### DETAILED DESCRIPTION OF THE DRAWINGS

In one aspect, a multi-purpose interrupter controls an external relay and is powered using low voltage DC supplied by either an AC/DC converter or a battery. The interrupter is preferably packaged inside an enclosure allowing it to be interchangeably used as a field portable instrument or interfaced with an RMU. In one embodiment, the multi-purpose interrupter incorporates an I/O port allowing interfacing with an RMU as well as a means of selecting and activating an interruption cycle when used as a portable device. In another embodiment, the multi-purpose interrupter is configured to operate from a low power DC source in a manner to minimize power consumption by selectively placing at least one power consuming process into sleep mode. In another embodiment, the multi-purpose interrupter includes a communication interface through which any interruption cycle can be programmed into the interrupter and activated. Throughout the description and the drawings, elements which are the same will be accorded the same reference numerals.

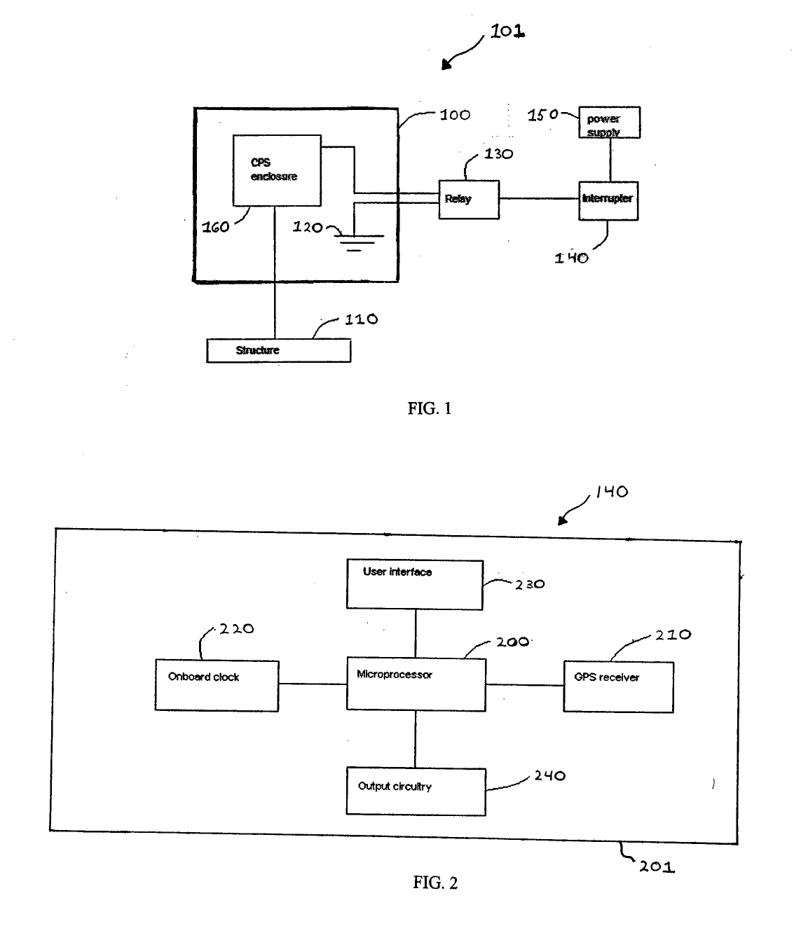

Referring now to FIG. 1, a schematic showing selected elements of one implementation of a cathodic protection configuration 101 is presented. In the depicted implementation, cathodic protection configuration 101 includes a multi-purpose interrupter 140 and associated relay 130 which are installed at or otherwise coupled to a CPS 100. In this embodiment, CPS 100 includes a cathodic protection rectifier having an anode and a cathode. The rectifier anode is coupled to relay 130, which is operable to connect the anode to groundbed 120. The cathodic protection rectifier cathode is connected to a buried structure 110. While structure 110 may be a pipeline carrying hazardous materials such as oil products or natural gas, it will be appreciated that buried structure 110 may be any buried structure requiring cathodic protection. CPS 100 is operable to bias buried structure 110 relative to groundbed 120 when relay 130 is closed. Relay 130 is connected in the current output circuit of CPS 100, and is operable to cycle the current output from CPS 100 between ON and OFF to facilitate an interrupted survey. It will be appreciated that relay 130 may be installed into any part of the CPS output current and it can also be installed on the AC input current (not shown) if CPS 100 is an impressed current system powered from primary AC supply. Also shown in FIG. 1 is multi-purpose interrupter 140 according to one embodiment of the present invention. In one embodiment of the present invention, multi-purpose interrupter 140 may be powered by power supply 150 and multi-purpose interrupter 140 is connected to, and controls opening and closing of relay 130 to cycle the output of CPS 100 between ON and OFF. In a preferred embodiment of the present invention, power supply 150 provides multi-purpose interrupter 140 with low voltage DC, typically in the range of 3 V to 15V. It will be appreciated that power supply 150 can be any source of low voltage DC, including but not limited to, an AC/DC converter, rechargeable batteries, or disposable batteries.

In one embodiment of the present invention, relay 130 and multi-purpose interrupter 140 are separate units, each housed inside its own enclosure. This arrangement has a number of benefits including multi-purpose interrupter 140 being significantly smaller than if both relay 130 and multi-purpose interrupter 140 were housed in one enclosure. A small size facilitates locating multi-purpose interrupter 140 within in a CPS enclosure 160 for additional protection from the elements as well as from vandalism and theft, appreciating that multi-purpose interrupter 140 is typically more expensive than either relay 130 or power supply 150.

A further benefit of relay 130 and multi-purpose interrupter 140 being separate is that the end user has a choice of what type and size of relay to use in a particular application. For instance, when switching bonds, small impressed current CPSs 100 and/or sacrificial CPSs 100, relays 130 capable of handling a relatively low capacity such as 10V/10 A or 100 W or less, are typically required. On the other hand, in the same system, an impressed current CPS 100 with a high output such as 50 A/50V or 2500 W or more may have to be interrupted. Furthermore, it may be desirous to interrupt any of the primary AC, the secondary AC, the DC positive output, or the DC negative output of any particular CPS 100. The depicted embodiment of the present invention has (as one of its advantages) permitting the end user to choose the type and size of relay 130.

One more benefit of relay 130 being separate is that more than one relay 130 can be controlled by one multi-purpose interrupter 140. Again, appreciating that multi-purpose interrupter 140 is typically the most valuable component required to interrupt CPS 100, multiple instances of the less expensive relay 130, controlled with only one multi-purpose interrupter 140, can be used at a location where multiple CPSs 100 or bonds exist within close proximity, such as within a 100 foot radius.

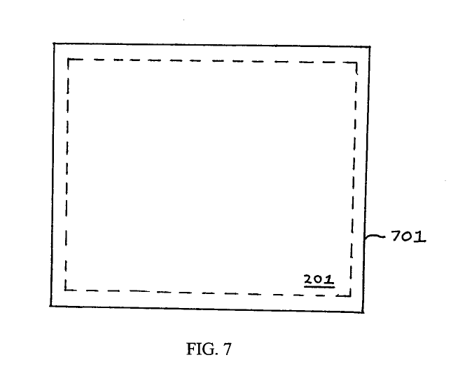

FIG. 2 is a block diagram showing selected sub-components of multi-purpose interrupter 140 according to one embodiment. In such embodiment, multi-purpose interrupter 140 includes enclosure 201, a microprocessor 200 to control functioning of the other sub-components, including GPS receiver 210, onboard clock 220, user interface 230, and output circuitry 240. Although not depicted, it will be appreciated that microprocessor 200 may be coupled to memory or other form of storage as is well known in the field of microprocessor based data processing systems. GPS receiver 210 periodically obtains an accurate time signal, allowing onboard clock 220 to be updated to ensure that any multiple instances of multi-purpose interrupters 140 or other interrupters are synchronized to within fractions of a second. User interface 230 provides a means of selecting, activating, and observing the functioning of multi-purpose interrupter 140. Output circuitry 240 provides a means for connecting multi-purpose interface 140 to relay 130. It will be appreciated that microprocessor 200 is programmed with software to control output circuitry 240, providing a signal to relay 130 (shown in FIG. 1), thereby facilitating switching of CPS 100 ON and OFF synchronously with at least one other similar device (e.g., another CPS connected to an adjacent portion of buried structure 110). In a preferred embodiment, enclosure 201 is constructed of plastic or other hardened material suitable for placement of multi-purpose interrupter 140 within CPS enclosure 160 and enclosure 201 is further configured for placement within rugged enclosure 701 (as depicted in FIG. 7). In one embodiment, rugged enclosure 701 may be constructed of semi-hard or hard plastic, rubber, or other suitable weather proof material to protect multi-purpose interrupter 140 from damage that may arise during transportation and usage in the field and associated strenuous field conditions. In such embodiment, enclosure 201 is sized so as to permit enclosure 201 to be located within CPS enclosure 160.

Referring back to FIG. 1, when AC power is not available at CPS 100, such as is the case with a sacrificial CPS 100 or when a bond (not shown) needs to be interrupted, rechargeable or disposable batteries may form the power source for power supply 150. Often, an interrupted survey may last for one week or more, and it is required for batteries to last for the duration of the survey, obviating the need for a visit to CPS 100 during the survey to replace or recharge batteries. The power consumption of multi-purpose interrupter 140 is therefore an important consideration.

Referring again to FIG. 2, the power consumption of multi-purpose interrupter 140 is determined by a number of factors including the power consumption of microprocessor 200, the power consumed by GPS receiver 210, the power consumed by user interface 230, and the power consumed by output circuitry 240. In a preferred embodiment of the present invention, the power consumed by microprocessor 200 may be minimized by limiting processing activity.

GPS receiver 210 updates onboard clock 220 with accurate time to eliminate errors caused by internal drift of onboard clock 220. The accuracy of onboard clock 220 may therefore be dictated by the frequency with which it is updated by the signal from GPS receiver 210. However, for the accuracy required to facilitate a valid interrupted survey, it is not necessary to update onboard clock 220 every second or even every minute. In fact, it will be appreciated that updating onboard clock 220 once every 30 minutes or even once every hour is sufficient for most situations. In a preferred embodiment of the present invention, GPS receiver 210 is activated periodically to minimize the power consumed. In one embodiment of the present invention, the frequency with which GPS receiver 210 updates onboard clock 220 is user selectable via programming or via an onboard selector, thereby allowing the user to select a high power, very accurate timing mode, or a low power, less accurate timing mode.

User interface 230 may consume power through alphanumeric and/or LED indicators. In one embodiment of the present invention, it is only during setup or when multi-purpose interrupter 140 is checked that these displays are active and these displays may be switched off at other times to conserve power. In one embodiment of the present invention, switching the display off may be a programmed function. In another embodiment of the present invention, switching the display off may be achieved with an on board selector.

Switching GPS receiver 210 and indicators on user interface 230 off for the majority of the time results in significant power savings. These processes preferably do not need to be active more than 10% of the time in a low power mode.

It will be appreciated that power consumption of output circuitry 240 varies according to the type of relay 130 (FIG. 2) used. Solid state relays, in particular field effect transistors, require very little charge to switch and using such devices conserves the power consumed by output circuitry 240.

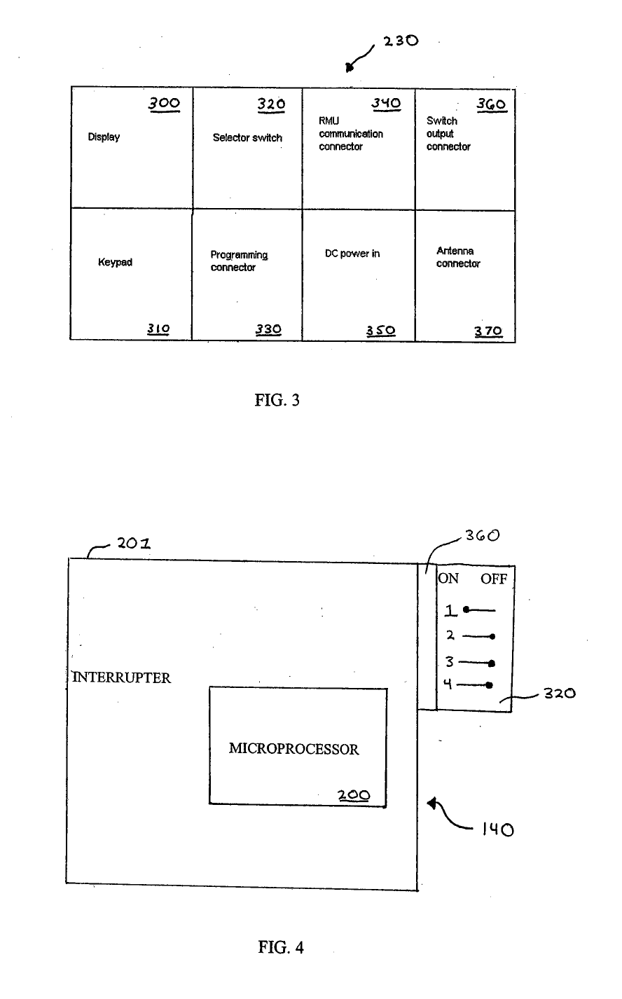

One embodiment of user interface 230 is shown in more detail in FIG. 3 and may incorporate a display 300, a keypad 310, a selector switch 320, a programming connector 330, an RMU communication connector 340, a DC power connector 350, a switch output connector 360, and an antenna connector 370. In one embodiment of the present invention, display 300 may be either an alphanumeric display or an LED display including one or more LED's configured to indicate applicable settings. In a preferred embodiment of the present invention, keypad 310 is optional and, if present, can be used to select and activate an interruption program. If keypad 310 is not present, selector switch 320 may be present and may be used to select and activate any one of a number of pre-programmed interruption cycles. These pre-programmed interruption cycles may be downloaded via programming connector 330 which interfaces multi-purpose interrupter 140 with a computer (not depicted). It will be appreciated that multi-purpose interrupter 140 may store one or more interruption cycles or programs therefore and any of such interruption cycles or programs may be modified or replaced with updated interruption cycles or programs downloaded as described above.

A method for interfacing multi-purpose interrupter 140 with an RMU is preferably provided with RMU communication connector 340, allowing the selection and activation of any one of a number of pre-programmed interruption cycles via a communication link between the RMU and a remote computer or other device (not depicted). It is appreciated that programming connector 330 and RMU communication connector 340 may be a single connector fulfilling both purposes. Furthermore, selector switch 320 may be a removable switch, designed to plug into programming connector 330, or into RMU communication connector 340. Furthermore, selector switch 320 may be any one of, but not limited to, a DIP switch, a push button switch, a rotary switch, a rocker switch, a slide switch, or a plug in jumper connector.

Referring now to FIG. 1 and FIG. 4, the use of multi-purpose interrupter 140 as a stand alone portable device is further explained. In this stand alone portable application shown in FIG. 1, multi-purpose interrupter 140 has selector switch 320 plugged into switch output connector 360 as shown in FIG. 4. In a preferred embodiment of the present invention, selector switch 320 is a 4-pole DIP switch. It will be appreciated, however, that it can be any switch allowing selection of at least one programming cycle. In the preferred embodiment, each pole of selector switch 320 connects individual poles in switch output connector 360 to ground which in turn is interpreted by microprocessor 200 as a command to initiate a specific programmed interruption cycle. In one embodiment, switch output connector 360 and selector switch 320 are located outside of enclosure 201. In another embodiment, switch output connector 360 and selector switch 320 may be encased within enclosure 201 or may be encased in their own separate enclosure. It is appreciated that a multi-pole selector switch 320 may also have the function of providing microprocessor 200 with an interruption cycle activation command through a combination of individual switch positions.

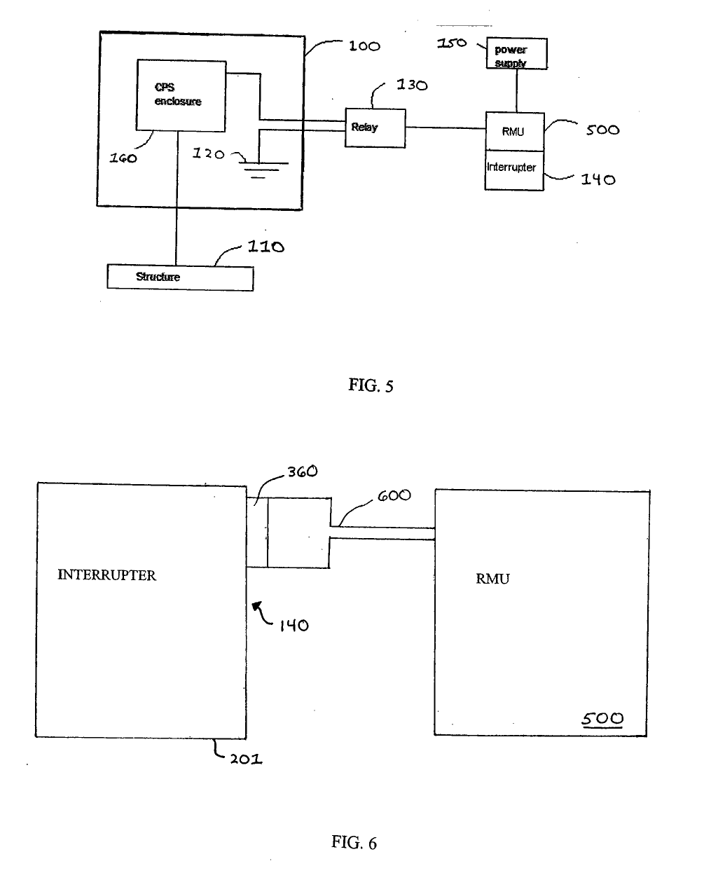

Referring now to FIG. 5, RMU 500 is interfaced to CPS 100, incorporating multi-purpose interrupter 140. In the present invention, multi-purpose interrupter 140 is the same device described in FIG.'s 1, 2 and 3, making it clear that multi-purpose interrupter 140 can be used interchangeably as either a portable and stand-alone interrupter or as a remotely accessible interrupter interfaced with RMU 500. In FIG. 5, both RMU 500 and multi-purpose interrupter 140 are powered with power supply 150. In certain applications, such as at sacrificial CPSs or bonds, AC power may not be available requiring RMU 500 and multi-purpose interrupter 140 to be powered with rechargeable batteries and a means of recharging the batteries such as solar power. In such an application, the low power consumption mode for multi-purpose interrupter 140 described above is especially important because it decreases the overall power requirement, thereby decreasing the size of solar panel required. It will be appreciated that RMU 500 may be used to download a new or revised interruption cycle program to multi-purpose interrupter 140, thereby avoiding the necessity of having to visit each CPS site physically to install a portable interrupter every time an interrupted survey needs to be carried out. Furthermore, RMU 500 may monitor functioning of multi-purpose interrupter 140 during an interrupted survey, thereby saving time and money in the event that interruption at any particular CPS fails during the survey.

According to one embodiment of the present invention, when multi-purpose interrupter 140 is interfaced with RMU 500, program selection and activation occurs via a connection between RMU 500 and multi-purpose interrupter 140, using RMU communication connector 340 (FIG. 3). In this application, RMU 500 selects and activates any one of a number of preprogrammed interruption programs on multi-purpose interrupter 140, using discrete signals such as digital outputs. In an alternative embodiment of the present invention, RMU 500 communicates with multi-purpose interrupter 140 through RMU communication connector using a suitable protocol including but not limited to RS232 serial communication. In this embodiment, it is possible for RMU 500 to program any interruption cycle into multi-purpose interrupter 140, thereby eliminating the need to visit the interrupter in the field to reprogram it with different interruption cycles.

The use of multi-purpose interrupter 140 interfaced with RMU 500 shown in FIG. 5 is further depicted in FIG. 6. FIG. 6 shows multi-purpose interrupter 140 interfaced with RMU 500 according to one embodiment of the present invention through a communication connector that includes a cable with connector 600 plugged into switch output connector 360 of multi-purpose interrupter 140. In this application where multi-purpose interrupter 140 is interfaced to and controlled by or possibly even programmed by RMU 500, the combination of RMU 500 and cable with connector 600 shown in FIG. 5 has therefore replaced selector switch 320 shown in FIG. 4. The interchangeable use of multi-purpose interrupter 140 as a stand alone portable device or interfaced to RMU 500 is depicted.

It is understood that the forms of the invention shown and described in the detailed description and the drawings are to be taken merely as presently preferred examples and that the invention is limited only by the language of the claims.

We claim:

1. A multi-purpose interrupter comprising:
a first enclosure for housing internal components of said multi-purpose interrupter;
wherein said multi-purpose interrupter is configured to interface with: one or more relays, a remote monitoring unit (RMU), and a selector switch, and wherein said multi-purpose interrupter is configured to be housed within an enclosure housing a cathodic protection rectifier; and
further wherein responsive to a signal from said RMU or said selector switch, said multi-purpose interrupter is configured to interrupt a current flow from said cathodic protection rectifier.

2. The multi-purpose interrupter of claim 1 wherein said internal components comprise:
a microprocessor;
a GPS receiver;
a user interface;
an onboard clock;
storage; and
output circuitry.

3. The multi-purpose interrupter of claim 2 wherein said user interface is configured to interface with said RMU and said output circuitry is configured to interface with said one or more relays.

4. A method for minimizing power consumption of the multi-purpose interrupter of claim 2 comprising limiting the frequency with which said onboard clock is updated.

5. The multi-purpose interrupter of claim 2 wherein said user interface comprises:
a display;
a selector switch;
a programming connector;
an RMU communication connector;
a DC power connector;
a switch output connector; and
an antenna connector.

6. The multi-purpose interrupter of claim 5 wherein said display is selected from the group consisting of an alphanumeric display and a LED display, wherein said LED display includes at least one LED configured to indicate internal settings of said multi-purpose interrupter.

7. The multi-purpose interrupter of claim 5 further comprising a keypad wherein said keypad is configured to select and activate an interruption program for said multi-purpose interrupter.

8. The multi-purpose interrupter of claim 5 wherein said selector switch is selected from the group consisting of a DIP switch, a push button switch, a rotary switch, a rocker switch, a slide switch, and a plug in jumper connector.

9. The multi-purpose interrupter of claim 5 wherein said selector switch is removable.

10. The multi-purpose interrupter of claim 1 wherein said multi-purpose interrupter is configured to be powered with low voltage DC.

11. The multi-purpose interrupter of claim 1 wherein said low voltage DC is in the range of 3V to 15V.

12. The multi-purpose interrupter of claim 1 wherein said first enclosure is configured for placement within a rugged enclosure.

13. The multi-purpose interrupter of claim 1 wherein said multi-purpose interrupter is configured to receive an interruption cycle program from said RMU.

14. A cathodic protection configuration, comprising:
a cathodic protection system including a cathodic protection rectifier having an anode and cathode;
a relay operable, in a closed position, to connect the anode to a groundbed; and
an interrupter coupled to the relay and operable to execute a program to cycle the relay between an open position and the closed position wherein the interrupter is operable in a stand alone configuration in which interrupter input is provided locally and wherein the interrupter is further operable in conjunction with a remote monitoring unit (RMU), wherein input to the interrupter is provided remotely via the RMU.

15. The cathodic protection configuration of claim 13 wherein said interrupter input may revise all or a portion of said program.
